(19) United States
(12) Patent Application Publication
(10) Pub. No.: US 2017/0285251 A1
(43) Pub. Date: Oct. 5, 2017

(54) LED BAR, BACKLIGHT MODULE, AND DISPLAY DEVICE

(71) Applicants: Le Holdings (Beijing) Co., Ltd., Beijing (CN); LE SHI ZHI XIN ELECTRONIC TECHNOLOGY (TIAN JIN) LIMITED, Tianjin (CN)

(72) Inventors: Kunpeng Zhu, Tianjin (CN); Zhishuai Jia, Tianjin (CN); Xianlei Meng, Tianjin (CN); Jinnan Zhang, Tianjin (CN); Fangdai Ye, Tianjin (CN)

(73) Assignees: Le Holdings (Beijing) Co., Ltd., Beijing (CN); LE SHI ZHI XIN ELECTRONIC TECHNOLOGY (TIAN JIN) LI MITED, Tianjin (CN)

(21) Appl. No.: 15/240,532

(22) Filed: Aug. 18, 2016

Related U.S. Application Data
(63) Continuation of application No. PCT/CN2016/088990, filed on Jul. 6, 2016.

(30) Foreign Application Priority Data
Mar. 30, 2016 (CN) 201620260977.1

(51) Int. Cl. F21V 8/00

(52) U.S. Cl. CPC G02B 6/0073; G02B 6/0091; G02B 6/0023

(57) ABSTRACT

Disclosed are a group of LED lamps, a backlight module, and a display device. The group of LED lamps includes a printed circuit board, a number of LEDs located on the printed circuit board and arranged in the long-side direction of the printed circuit board, and a connection terminal located at one end of the printed circuit board, wherein the surface of the connection terminal is provided with a white light photo-luminescent coating. With the technical solution according to the embodiments of the disclosure, a dark corner in a picture of the backlight module can be alleviated to thereby improve the quality of displaying on the display device.

### CROSS REFERENCE TO RELATED APPLICATIONS

This application is a continuation of International Application No. PCT/CN2016/088990, filed on Jul. 6, 2016, which is based upon and claims priority to Chinese Patent Application No. 201620260977.1, filed on Mar. 30, 2016, the entire contents of which are incorporated herein by reference.

### TECHNICAL FIELD

The present disclosure relates to the field of display technologies, and particularly to a LED BAR, a backlight module, and a display device.

### BACKGROUND

Light Emitting Diodes (LEDs) are commonly used as light sources in a backlight module of a display device. The backlight module can be categorized into a direct-type backlight module, and an edge-lighting type backlight module, dependent upon the positions where the light sources are distributed, where the structure of the edge-lighting type backlight module generally includes: a rear panel including an accommodating space; a reflecting sheet, a light guide plate, and an optical film sheet which are arranged in that order in the accommodating space of the rear panel; and a LED BAR located between a light incidence end side of the light guide plate, and sidewalls of the rear panel; and a plastic frame located above the optical film sheet and assembled with the rear panel.

As illustrated in FIG. 1, the existing LED BAR 10 includes a long strip-like printed circuit board 11, a number of LEDs 12 installed in the long-side direction of the printed circuit board 11, and a connection terminal 13 located at one end of the printed circuit board 11, where such a significant space is occupied by the connection terminal 13 with a large size that the light guide plate 20 is typically grooved to reserve the space for the connection terminal 13.

The inventors have identified during making of the disclosure at least the following problems in the prior art: there may be a dark zone in a picture of the backlight module at the corner where the connection terminal is located, thus reducing the optical quality of the display device; and moreover the existing connection terminal typically made of a plastic material is fixed on the printed circuit board using adhesive glue, so that when the display device vibrates and falls down during a test, the connection terminal being impacted by the light guide plate may fall away from the printed circuit board, so that the LED BAR may suffer from poor circuit contact, thus reducing the optical quality.

### SUMMARY

Embodiments of the disclosure provide a LED BAR, a backlight module, and a display device so as to alleviate the dark corner in the picture of the backlight module, and to improve the quality of displaying on the display device.

A LED BAR according to some embodiments of the disclosure includes a printed circuit board, a plurality of LEDs located on the printed circuit board and arranged in a long-side direction of the printed circuit board, and a connection terminal located at one end of the printed circuit board 31, wherein the surface of the connection terminal is provided with a white light photoluminescent coating.

In some embodiments, the surface of the connection terminal facing the light incidence end face of the light guide plate is structured as a sphere.

In some embodiments, the surface of the connection terminal facing the light incidence end face of the light guide plate is structured as an arch.

In some embodiments, the vault line of the arch structure is arranged in the long-side direction of the printed circuit board.

In some embodiments, the vault line of the arch structure is arranged in the short-side direction of the printed circuit board.

In some embodiments, the white light photoluminescent coating is a rare-earth long-afterglow phosphor coating.

More preferably the connection terminal includes a rubber surface layer.

If the LED BAR according to embodiments of the disclosure is applicable to a backlight module, then since the surface of the connection terminal is provided with the white light photoluminescent coating, so uniform white light will be emitted from the surface of the connection terminal illuminated by the LEDs which are light sources to thereby alleviate in effect a dark corner in a picture of the backlight module so as to improve the quality of displaying on a display device.

Some embodiments of the disclosure further provide a backlight module including a light guide plate, and the LED BAR according to any one of the technical solutions above, wherein the light guide plate includes a groove making room for the connection terminal. As compared with the prior art, the dark corner in the picture of the backlight module can be alleviated to thereby improve the quality of displaying on the display device.

In some embodiments, the connection terminal contacts with the light incidence end face of the light guide plate.

Some embodiments of the disclosure further provide a display device including the backlight module according to the technical solution above. Since the dark corner in the picture of the backlight module can be alleviated, the product quality of the display device will be improved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram of the LED BAR and the light guide plate in the prior art;

FIG. 2 is a schematic structural diagram of a LED BAR and a light guide plate according to some embodiments of the disclosure;

FIG. 3 is a schematic diagram of a LED BAR emitting light according to some embodiments of the disclosure;

FIG. 4 is a schematic structural diagram of a LED BAR according to some embodiments of the disclosure; and

FIG. 5 is a schematic structural diagram of a LED BAR according to some embodiments of the disclosure.

### REFERENCE NUMERALS

In the prior art:

10—LED BAR; 20—Light guide plate; 11—Printed circuit board; 12—LED; 13—Connection terminal.

In embodiments of the disclosure:

30—LED BAR; 40—Light guide plate; 31—Printed circuit board; 32—LED; 33—Connection terminal; 41—Groove.

### DETAILED DESCRIPTION

In order to make the objects, technical solutions, and advantages of the embodiments of the disclosure more apparent, the technical solutions according to embodiments of the disclosure will be described below clearly and fully with reference to the drawings in embodiments of the disclosure, and apparently the embodiments described below are only a part but not all of embodiments of the disclosure. Based upon embodiments here of the disclosure, all the other embodiments which can occur to those skilled in the art without any inventive effort shall fall into the scope of the disclosure.

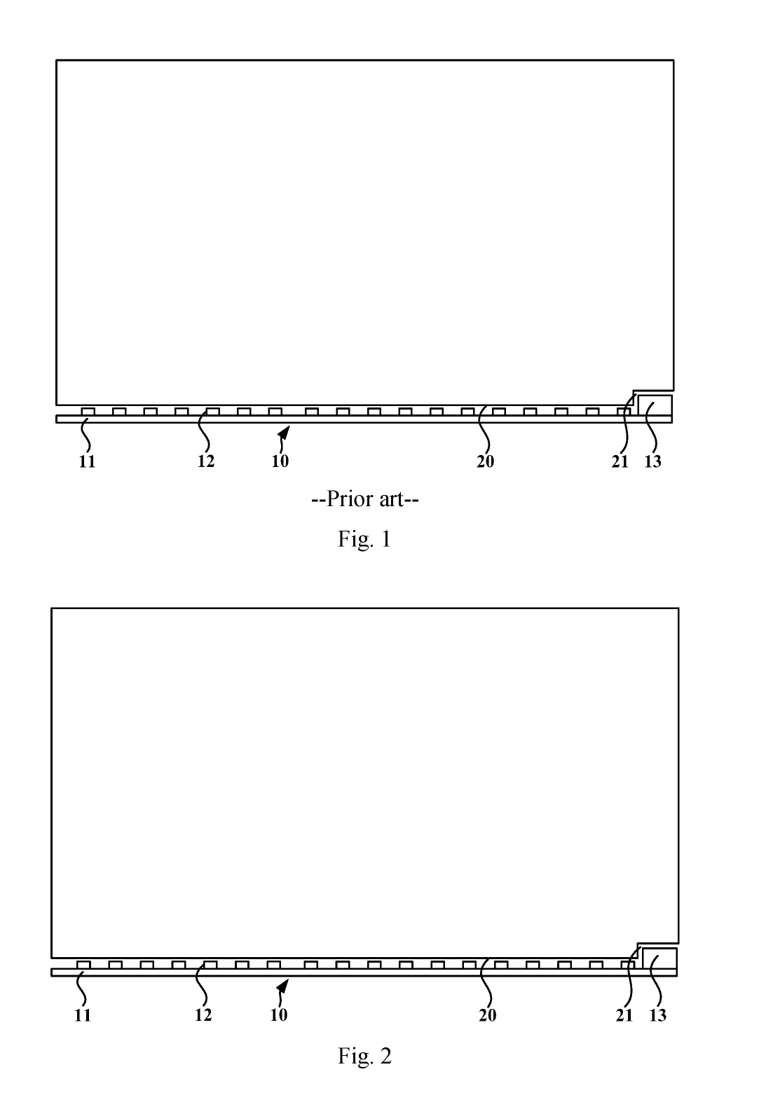

As illustrated in FIG. 2 and FIG. 3, a LED BAR 30 according to some embodiments of the disclosure includes a printed circuit board 31, a number of LEDs 32 located on the printed circuit board 31 and arranged in the long-side direction of the printed circuit board 31, and a connection terminal 33 located at one end of the printed circuit board 31, where the surface of the connection terminal 33 is provided with a white light photoluminescent coating.

With the technical solution according to embodiments of the disclosure, the surface of the connection terminal 33 is provided with the white light photoluminescent coating, so uniform white light will be emitted from the surface of the connection terminal 33 illuminated by the LEDs 32 which are light sources to thereby alleviate in effect a dark corner in a picture of a backlight module so as to improve the quality of displaying on a display device.

As illustrated in FIG. 4, in some embodiments of the disclosure, the surface of the connection terminal 33 facing the light incidence end face of the light guide plate is structured as a sphere. With this technical solution, the surface area of the connection terminal 33 can be increased to thereby increase the illumination range of the connection terminal 33, and the white light emitted by the connection terminal can better illuminate the light incidence end face of the light guide plate to thereby further alleviate in effect the dark corner in the picture of the backlight module so as to further improve the quality of displaying on the display device.

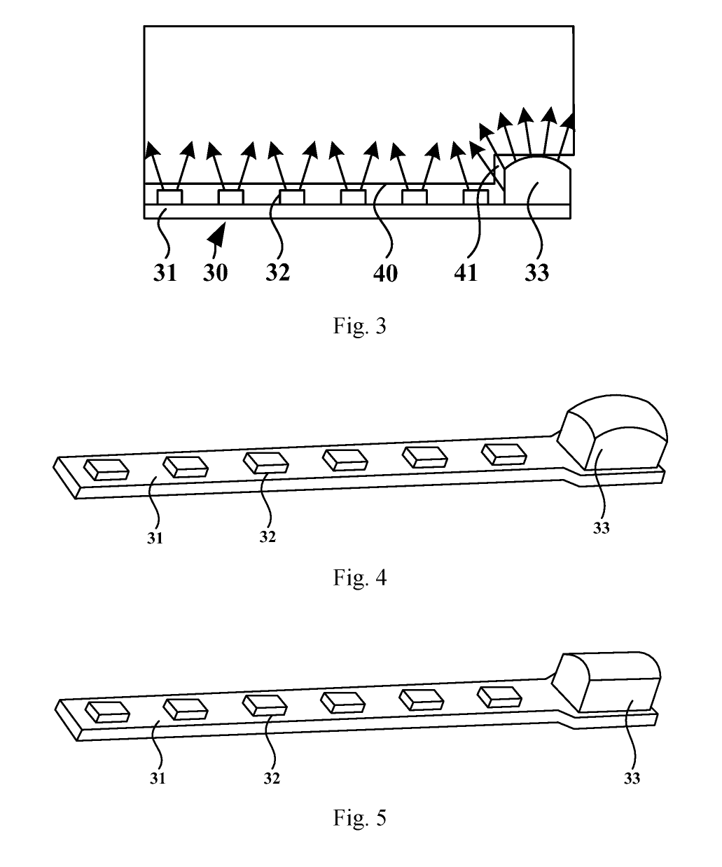

In some embodiments of the disclosure, the surface of the connection terminal 33 facing the light incidence end face of the light guide plate is structured as an arch. As illustrated in FIG. 3, the vault line of the arch structure is arranged in the long-side direction of the printed circuit board 31; or as illustrated in FIG. 5, the vault line of the arch structure is arranged in the short-side direction of the printed circuit board 31. With this technical solution, the surface area of the connection terminal 33 can also be increased to thereby increase the illumination range of the connection terminal 33, and the white light emitted by the connection terminal can better illuminate the light incidence end face of the light guide plate to thereby further alleviate in effect the dark corner in the picture of the backlight module so as to further improve the quality of displaying on the display device.

Furthermore it shall be noted that the arch structure will not be limited to any particular structure, e.g., a parabolic shape, a circular arc, etc.

In some embodiments, the white light photoluminescent coating is a rare-earth long-afterglow phosphor coating. The rare-earth long-afterglow phosphor is stable and has long afterglow persistence, so the white light photoluminescent coating can provide the display device with a more stable light source to thereby improve the quality of the display device.

In some embodiments of the disclosure, the connection terminal includes a rubber surface layer. With this technical solution, when the display device vibrates and falls down during a test, an impact of the light guide plate on the connection terminal will be buffered by the rubber surface layer of the connection terminal, so that the connection terminal can be fixed on the printed circuit board more firmly to thereby make the circuit connection in the LED BAR more reliable so as to improve the quality of the display device.

As illustrated in FIG. 2, some embodiments of the disclosure further provides a backlight module including a light guide plate 40, and the LED BAR 30 according to any one of the technical solutions above, where the light guide plate 40 includes a groove 41 making room for the connection terminal 33. The light guide plate 40 includes the groove 41 making room for the connection terminal 33 to thereby make the backlight module more compact in structure, so that the white light emitted by the LED BAR 30 can better illuminate the light incidence end face of the light guide plate to thereby improve the optical efficiency of the display device. The dark corner in the picture of the backlight module can be alleviated to thereby improve the quality of displaying on the display device.

In some embodiments of the disclosure, the connection terminal 33 contacts with the light incidence end face of the light guide plate 40 so that it will be convenient to position and assemble the LEDs 32 and the light guide plate 40, and the impact of the end face of the light guide plate on the LEDs can be mitigated to thereby further improve the product quality of the display device.

In summary, as compared with the prior art, the dark corner in the picture of the backlight module according to the embodiments of the disclosure can be alleviated to thereby improve the quality of displaying on the display device, and furthermore improve the reliability of the LED BAR in use, and the product quality of the display device.

Some embodiments of the disclosure further provide a display device including the backlight module according to the technical solution above. Since the dark corner in the picture of the backlight module can be alleviated, the product quality of the display device will be improved. The display device will not be limited to any particular type, for example, the display device can be a liquid crystal TV set, a liquid crystal display screen, etc.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

1-10. (canceled)

11. A LED BAR, comprising a printed circuit board, a plurality of LEDs located on the printed circuit board and arranged in a long-side direction of the printed circuit board, and a connection terminal located at one end of the printed circuit board, wherein a surface of the connection terminal is provided with a white light photoluminescent coating.

12. The LED BAR according to claim 11, wherein a surface of the connection terminal facing the light incidence end face of the light guide plate is structured as a sphere.

13. The LED BAR according to claim 11, wherein a surface of the connection terminal facing the light incidence end face of the light guide plate is structured as an arch.

14. The LED BAR according to claim 13, wherein the vault line of the arch structure is arranged in the long-side direction of the printed circuit board.

15. The LED BAR according to claim 13, wherein the vault line of the arch structure is arranged in a short-side direction of the printed circuit board.

16. The LED BAR according to claim 11, wherein the white light photoluminescent coating is a rare-earth long-afterglow phosphor coating.

17. The LED BAR according to claim 11, wherein the connection terminal comprises a rubber surface layer.

18. A backlight module, comprising a light guide plate, and a LED BAR, wherein the light guide plate comprises a groove making room for the connection terminal;
wherein the LED BAR comprises a printed circuit board, a plurality of LEDs located on the printed circuit board and arranged in a long-side direction of the printed circuit board, and a connection terminal located at one end of the printed circuit board, wherein a surface of the connection terminal is provided with a white light photoluminescent coating.

19. The backlight module according to claim 18, wherein a surface of the connection terminal facing the light incidence end face of the light guide plate is structured as a sphere.

20. The backlight module according to claim 18, wherein a surface of the connection terminal facing the light incidence end face of the light guide plate is structured as an arch.

21. The backlight module according to claim 20, wherein the vault line of the arch structure is arranged in the long-side direction of the printed circuit board.

22. The backlight module according to claim 20, wherein the vault line of the arch structure is arranged in a short-side direction of the printed circuit board.

23. The backlight module according to claim 18, wherein the white light photoluminescent coating is a rare-earth long-afterglow phosphor coating.

24. The backlight module according to claim 18, wherein the connection terminal comprises a rubber surface layer.

25. The backlight module according to claim 18, wherein the connection terminal contacts with the light incidence end face of the light guide plate.

26. A display device, comprising a backlight module, wherein backlight module comprises a light guide plate, and a LED BAR, wherein the light guide plate comprises a groove making room for the connection terminal;
wherein the LED BAR comprises a printed circuit board, a plurality of LEDs located on the printed circuit board and arranged in a long-side direction of the printed circuit board, and a connection terminal located at one end of the printed circuit board, wherein a surface of the connection terminal is provided with a white light photoluminescent coating.

27. The display device according to claim 26, wherein a surface of the connection terminal facing the light incidence end face of the light guide plate is structured as a sphere.

28. The display device according to claim 26, wherein a surface of the connection terminal facing the light incidence end face of the light guide plate is structured as an arch.

29. The display device according to claim 28, wherein the vault line of the arch structure is arranged in the long-side direction of the printed circuit board.

30. The display device according to claim 28, wherein the vault line of the arch structure is arranged in a short-side direction of the printed circuit board.

31. The display device according to claim 26, wherein the white light photoluminescent coating is a rare-earth long-afterglow phosphor coating.

32. The display device according to claim 26, wherein the connection terminal comprises a rubber surface layer.

33. The display device according to claim 26, wherein the connection terminal contacts with the light incidence end face of the light guide plate.
